(19) United States
(12) Patent Application Publication
(10) Pub. No.: US 2026/0226913 A1
(43) Pub. Date: Aug. 6, 2026

(54) BLOWER

(71) Applicants: KABUSHIKI KAISHA TOSHIBA, Kawasaki-shi (JP); Carrier Japan Corporation, Tokyo (JP)

(72) Inventor: Yuki FURUTANI, Hiratsuka (JP)

(73) Assignees: KABUSHIKI KAISHA TOSHIBA, Kawasaki-shi (JP); Carrier Japan Corporation, Tokyo (JP)

(21) Appl. No.: 19/434,142

(22) Filed: Dec. 29, 2025

(30) Foreign Application Priority Data
Feb. 3, 2025 (JP) 2025-016393

(51) Int. Cl. F04D 29/30; F04D 17/16; F04D 29/28

(52) U.S. Cl. CPC F04D 29/30; F04D 17/16; F04D 29/281

(57) ABSTRACT

According to an embodiment, a blower includes a bell mouth and an impeller. The bell mouth includes an opening portion. The impeller is provided at the opening portion. The impeller includes a blade portion including a leading edge portion. The impeller is configured to rotate. The leading edge portion includes a plurality of recesses. The plurality of recesses are arranged in a direction of rotation of the impeller.

### CROSS-REFERENCE TO RELATED APPLICATIONS

This application is based upon and claims the benefit of priority from Japanese Patent Application No.2025-016393, filed on Feb. 3, 2025; the entire contents of which are incorporated herein by reference.

### FIELD

Embodiments of the invention relate to a blower.

### BACKGROUND

Examples of blowers include centrifugal blowers and axial blowers. It is desirable for blowers to attain improved characteristics, such as improved static pressure and reduced noise. In blowers, separation from the leading edge portions of the blades or the curved surface portion of the bell mouth may occur, which may result in a drop of the static pressure due to an increase in fluid resistance, and generation of noise caused by pressure fluctuations due to vortex generation and motion.

### BRIEF DESCRIPTION OF THE DRAWINGS

FIG. 1 is a schematic diagram showing an example of a blower according to an embodiment.

FIG. 2 is a schematic diagram showing a part of the blower according to the embodiment.

FIG. 3 is a schematic diagram showing a part of the blower according to the embodiment.

FIG. 4 is a schematic diagram showing a part of the blower according to the embodiment.

FIG. 5 is a schematic diagram showing a part of the blower according to the embodiment.

FIG. 6 is a schematic diagram showing a part of the blower according to the embodiment.

FIG. 7 is a diagram showing characteristics of the blower according to the embodiment.

FIG. 8 is a schematic diagram showing a part of the blower according to the embodiment.

FIG. 9 is a schematic diagram showing a part of the blower according to the embodiment.

FIG. 10 is a schematic diagram showing an example of the blower according to the embodiment.

FIG. 11 is a schematic diagram showing a part of the blower according to the embodiment.

FIG. 12 is a schematic diagram showing a part of the blower according to the embodiment.

FIG. 13 is a diagram showing characteristics of the blower according to the embodiment.

FIG. 14 is a schematic diagram showing a part of the blower according to the embodiment.

FIG. 15 is a schematic diagram showing a part of the blower according to the embodiment.

FIG. 16 is a diagram showing characteristics of the blower according to the embodiment.

FIG. 17 is a schematic diagram showing a part of the blower according to the embodiment.

FIG. 18 is a schematic diagram showing a part of the blower according to the embodiment.

FIG. 19 is a schematic diagram showing a part of the blower according to the embodiment.

FIG. 20 is a diagram showing characteristics of the blower according to the embodiment.

### DETAILED DESCRIPTION

According to an embodiment of the invention, a blower includes a bell mouth and an impeller. The bell mouth includes an opening portion. The impeller is provided at the opening portion. The impeller includes a blade portion including a leading edge portion. The impeller is configured to rotate. The leading edge portion includes a plurality of recesses. The plurality of recesses are arranged in a direction of rotation of the impeller.

Hereinafter, embodiments of the invention will be described with reference to the drawings.

The drawings are schematic or conceptual, and the relationship between the thickness and width of each portion, the proportions of sizes among portions, and the like are not necessarily the same as the actual values. Even the dimensions and proportion of the same portion may be illustrated differently depending on the drawing.

In the specification and drawings, components similar to those described in regard to a drawing thereinabove are marked with like reference numerals, and a detailed description is omitted as appropriate.

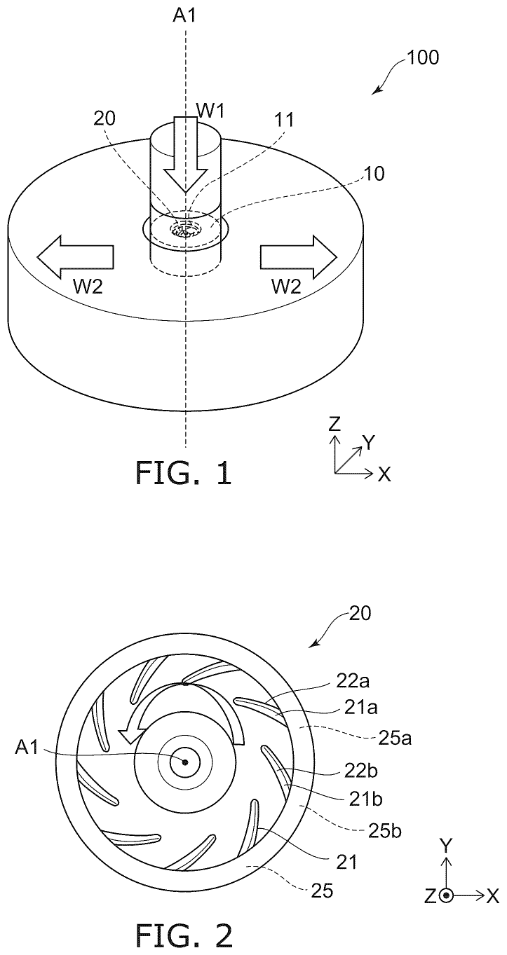

FIG. 1 is a schematic diagram showing an example of a blower according to an embodiment.

As shown in FIG. 1, a blower 100 according to the embodiment includes a bell mouth 10 and an impeller 20. The bell mouth 10 includes an opening portion 11. The impeller 20 rotates around an axis A1.

FIG. 2 is a schematic diagram showing a part of the blower according to the embodiment.

As shown in FIG. 2, the impeller 20 includes a blade portion 21. The impeller 20 includes a plurality of blade portions 21a and 21b. The impeller 20 rotates, for example, in the direction of rotation indicated by the arrow shown in FIG. 2. The plurality of blade portions 21a and 21b are provided in the circumferential direction.

The impeller 20 includes a leading edge portion 22 and a trailing edge portion 25. The leading edge portion 22 extends toward the inside of the impeller 20 from the trailing edge portion 25. The leading edge portion 22 is the foremost edge of the blade portion 21 and is a portion that first encounters opposing air. The plurality of blade portion 21a and 21b respectively include leading edge portions 22a and 22b and trailing edge portions 25a and 25b.

As shown in FIGS. 1 and 2, the blower 100 according to the embodiment may be, for example, a centrifugal blower. As shown in FIG. 1, air flows in the direction W2 indicated by the arrow shown in FIG. 1 from the direction W1 indicated by the arrow shown in FIG. 1.

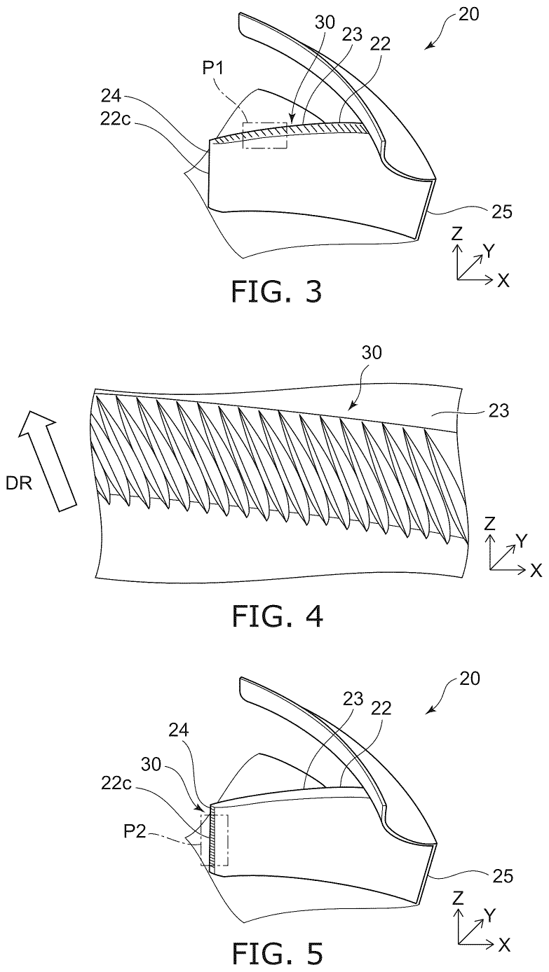

FIG. 3 is a schematic diagram showing a part of the blower according to the embodiment.

FIG. 4 is a schematic diagram showing a part of the blower according to the embodiment. The region P1 shown in FIG. 3 is shown in FIG. 4.

As shown in FIGS. 3 and 4, the leading edge portion 22 includes a plurality of recesses 30. The plurality of recesses 30 are arranged in the direction of rotation DR of the impeller 20.

It is known that a higher static pressure contributes to, for example, improvement in the performance of, for example, a heat exchanger. Since the leading edge portion 22 includes the plurality of recesses 30, separation of the air around the plurality of recesses 30 can be reduced. This increases the static pressure. As a result, a pressure drop of the air around the plurality of recesses 30 and vortex generation due to separation are reduced, and the noise of the blower 100 is suppressed. Improved characteristics can be attained.

The plurality of recesses 30 may be riblets. The pitch of the riblets may be 0.5 mm or more and 4.0 mm or less. This further increases the static pressure, and suppresses a pressure drop of the air around the plurality of recesses 30 and the noise of the blower 100. Improved characteristics can be attained.

The depth of the riblets may be 0.2 mm or more and 2.0 mm or less. This further increases the static pressure, and further suppresses a pressure drop of the air around the plurality of recesses 30 and the noise of the blower 100. Improved characteristics can be attained.

As shown in FIGS. 3 and 4, the leading edge portion 22 includes a first portion 23 and a second portion 24. The second portion 24 extends from the first portion 23 in the direction of the axis A1. The second portion 24 is a front end 22c of the blade portion 21. The plurality of recesses 30 may be provided in the first portion 23. The plurality of recesses 30 may be provided in a part or all of the first portion 23.

FIG. 5 is a schematic diagram showing a part of the blower according to the embodiment.

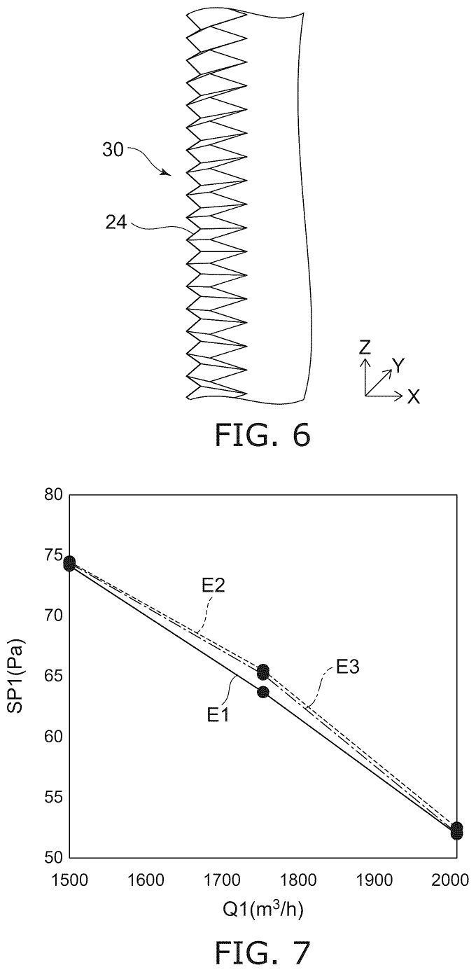

FIG. 6 is a schematic diagram showing a part of the blower according to the embodiment. The region P2 shown in FIG. 5 is shown in FIG. 6.

As shown in FIGS. 5 and 6, the plurality of recesses 30 may be provided in the second portion 24. The plurality of recesses 30 may be provided in a part or all of the second portion 24.

FIG. 7 is a diagram showing characteristics of the blower according to the embodiment. The horizontal axis shown in FIG. 7 represents the air flow rate Q1 (m³/h). The vertical axis represents the static pressure SP1 (Pa). FIG. 7 shows the PQ characteristics. The characteristic E1 shown in the solid line corresponds to a first reference example in which the leading edge portion 22 does not include the plurality of recesses 30. The characteristic E2 shown in the dashed line corresponds to the embodiment in which the plurality of recesses 30 are provided in the first portion 23. The characteristic E3 shown in the dash-dotted line corresponds to the embodiment in which the plurality of recesses 30 are provided in the second portion 24.

As shown in FIG. 7, the static pressures SP1 of the characteristics E2 and E3 are higher than the static pressure SP1 of the characteristic E1. This is because separation of the air around the plurality of recesses 30 is reduced. As a result, a pressure drop of the air around the plurality of recesses 30 and the noise of the blower 100 are suppressed. Improved characteristics can be attained.

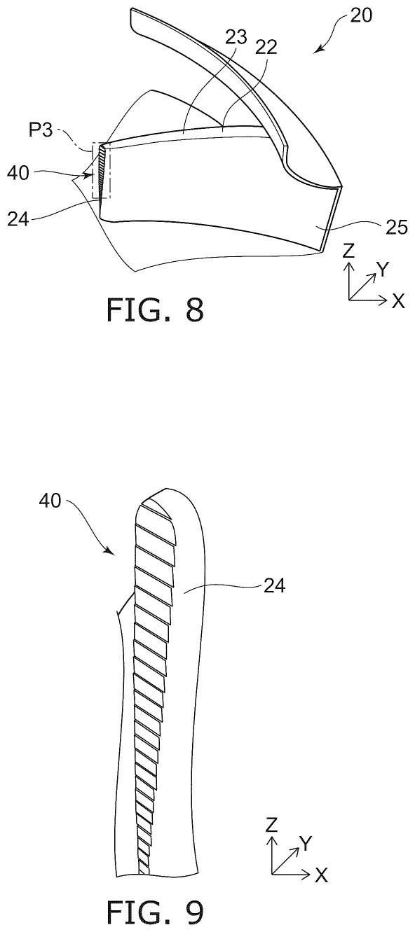

FIG. 8 is a schematic diagram showing a part of the blower according to the embodiment.

FIG. 9 is a schematic diagram showing a part of the blower according to the embodiment. The region P3 shown in FIG. 8 is shown in FIG. 9.

As shown in FIGS. 8 and 9, the second portion 24 includes a plurality of steps 40. The plurality of steps 40 may be retracted in a direction from the inside to the outside of the impeller 20 along the direction of the axis A1. This increases the static pressure, and suppresses a pressure drop of the air around the plurality of steps 40 and the noise of the blower 100. Improved characteristics can be attained. The plurality of steps 40 may be provided on a part or all of the second portion 24. Manufacture using a mold, of the blade portion 21 including the plurality of steps 40 is easier than manufacture using a mold, of the blade portion 21 including the plurality of recesses 30.

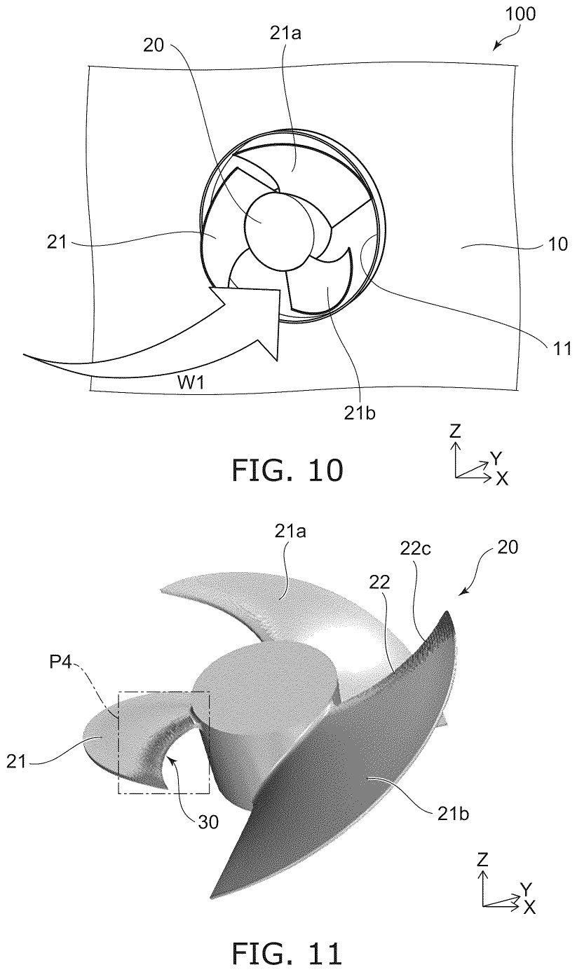

FIG. 10 is a schematic diagram showing an example of the blower according to the embodiment.

As shown in FIG. 10, the blower according to the embodiment may be, for example, an axial blower. The blower 100 according to the embodiment includes the bell mouth 10 and the impeller 20. The bell mouth 10 includes the opening portion 11. The impeller 20 includes the blade portion 21. The blade portion 21 includes the plurality of blade portions 21a and 21b. The plurality of blade portions 21a and 21b are provided in the circumferential direction. Air flows in the Y-axis direction from the direction W1 indicated by the arrow shown in FIG. 10.

FIG. 11 is a schematic diagram showing a part of the blower according to the embodiment.

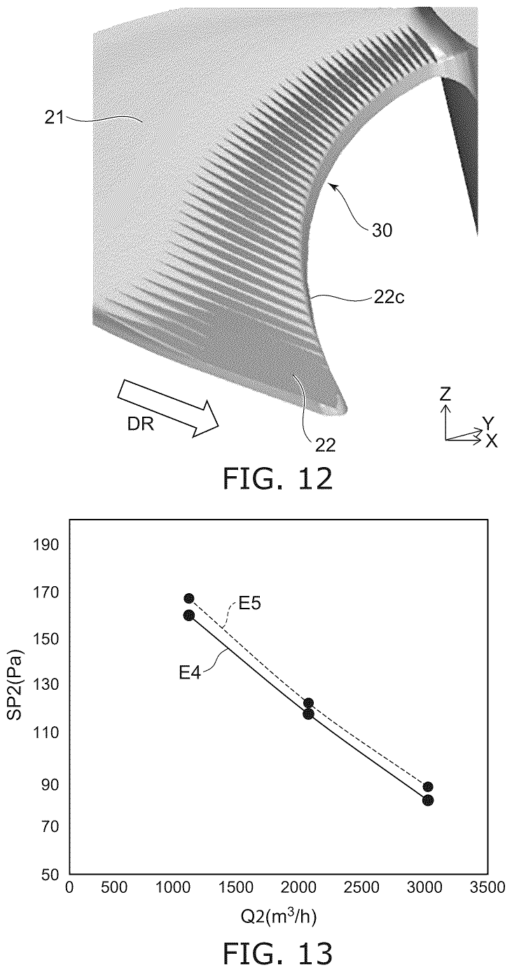

FIG. 12 is a schematic diagram showing a part of the blower according to the embodiment. The region P4 shown in FIG. 11 is shown in FIG. 12.

As shown in FIGS. 11 and 12, the leading edge portion 22 includes the plurality of recesses 30. The plurality of recesses 30 are arranged in the direction of rotation DR of the impeller 20. The plurality of recesses 30 are provided in the front end 22c of the blade portion 21 in the direction of rotation DR. This increases the static pressure, and suppresses a pressure drop of the air around the plurality of recesses 30 and the noise of the blower 100. Improved characteristics can be attained. The plurality of recesses 30 may be provided in a part or all of the leading edge portion 22.

FIG. 13 is a diagram showing characteristics of the blower according to the embodiment. The horizontal axis shown in FIG. 13 represents the air flow rate Q2 (m³/h). The vertical axis represents the static pressure SP2 (Pa). FIG. 13 shows the PQ characteristics. The characteristic E4 shown in the solid line corresponds to a second reference example in which the leading edge portion 22 does not include the plurality of recesses 30. The characteristic E5 shown in the dashed line corresponds to the embodiment in which the plurality of recesses 30 are provided in the leading edge portion 22.

As shown in FIG. 13, the static pressure SP2 of the characteristic E5 is higher than the static pressure SP2 of the characteristic E4. This is because separation of the air around the plurality of recesses 30 is reduced. As a result, a pressure drop of the air around the plurality of recesses 30 and the noise of the blower 100 are suppressed. Improved characteristics can be attained.

The plurality of recesses 30 may be riblets. The pitch of the riblets and the depth of the riblets are as described above.

The blade portion 21 of the blower 100 according to the embodiment may be used as the blade portion of a wind turbine. Providing the plurality of recesses 30 in the leading edge portion of the blade portion of a wind turbine can be expected to suppress a pressure drop of the surrounding air and the noise of the wind turbine.

The blade portion 21 of the blower 100 according to the embodiment may be used as the blade portion of a water turbine or a pump. Providing the plurality of recesses 30 in the leading edge portion of the blade portion of a water turbine or a pump can be expected to suppress a drop of the pressure of the surrounding water and cavitation caused by the drop of the water pressure.

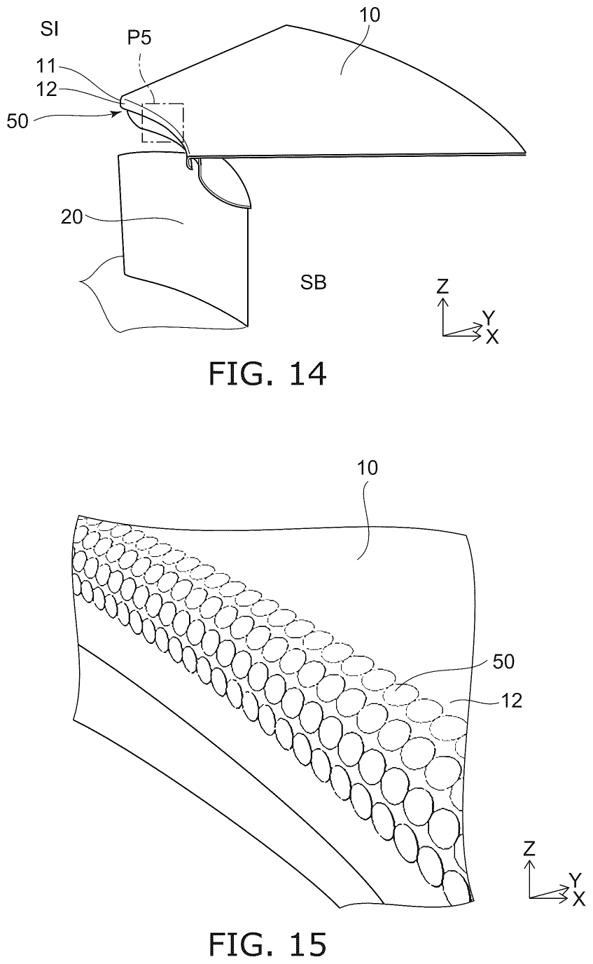

FIG. 14 is a schematic diagram showing a part of the blower according to the embodiment.

FIG. 15 is a schematic diagram showing a part of the blower according to the embodiment. The region P5 shown in FIG. 14 is shown in FIG. 15.

The blower 100 shown in FIGS. 14 and 15 is an example centrifugal blower. As shown in FIGS. 14 and 15, the opening portion 11 includes a curved surface 12. The curved surface 12 includes a plurality of irregularities 50. In FIG. 14, the plurality of irregularities 50 are provided on the air intake side SI. The plurality of irregularities 50 may be provided on a part or all of the curved surface 12.

The plurality of irregularities 50 may be dimples. The pitch of the dimples may be 2.0 mm or more and 6.0 mm or less. This further increases the static pressure, and further suppresses a pressure drop of the air around the plurality of irregularities 50 and the noise of the blower 100. Improved characteristics can be attained.

The depth of the dimples may be 0.2 mm or more and 0.7 mm or less. This further increases the static pressure, and further suppresses a pressure drop of the air around the plurality of irregularities 50 and the noise of the blower 100. Improved characteristics can be attained.

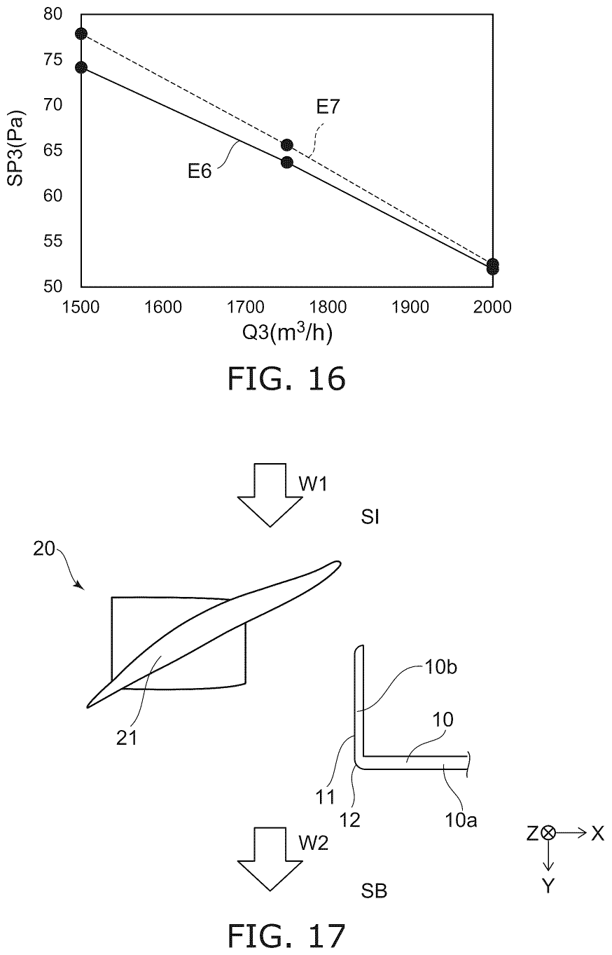

FIG. 16 is a diagram showing characteristics of the blower according to the embodiment. The horizontal axis shown in FIG. 16 represents the air flow rate Q3 (m³/h). The vertical axis represents the static pressure SP3 (Pa). FIG. 16 shows the PQ characteristics. The characteristic E6 shown in the solid line corresponds to a third reference example in which the curved surface 12 does not include the plurality of irregularities 50. The characteristic E7 shown in the dashed line corresponds to the embodiment in which the plurality of irregularities 50 are provided on the curved surface 12.

As shown in FIG. 16, the static pressure SP3 of the characteristic E7 is higher than the static pressure SP3 of the characteristic E6. This is because air separation is reduced on the curved surface 12 on the blowoff side SB. As a result, a pressure drop of the air around the plurality of recesses 30 and vortex generation caused by separation are reduced, and the noise of the blower 100 is suppressed. Improved characteristics can be attained.

FIG. 17 is a schematic diagram showing a part of the blower according to the embodiment.

The blower shown in FIG. 17 is an example axial blower. As shown in FIG. 17, the bell mouth 10 includes a base portion 10a and a rising portion 10b. The opening portion 11 includes the curved surface 12. The curved surface 12 is located between the base portion 10a and the rising portion 10b. Air flows in the direction W2 indicated by the arrow shown in FIG. 17 from the direction W1 indicated by the arrow shown in FIG. 17. The curved surface 12 is provided on the blowoff side SB.

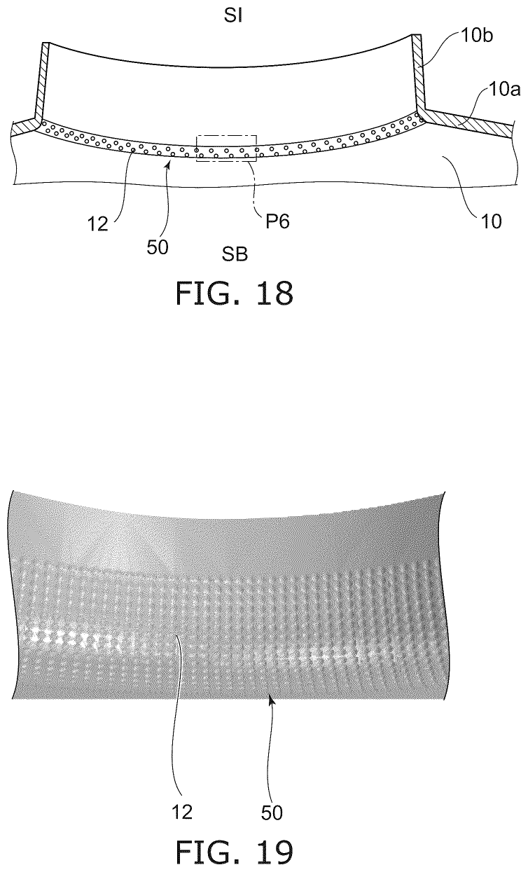

FIG. 18 is a schematic diagram showing a part of the blower according to the embodiment.

FIG. 19 is a schematic diagram showing a part of the blower according to the embodiment. The region P6 shown in FIG. 18 is shown in FIG. 19.

As shown in FIGS. 18 and 19, the curved surface 12 includes the plurality of irregularities 50. The plurality of irregularities 50 are provided on the blowoff side SB. The plurality of irregularities 50 may be provided on a part or all of the curved surface 12. The plurality of irregularities 50 may be dimples. The pitch and depth of the dimples are as described above.

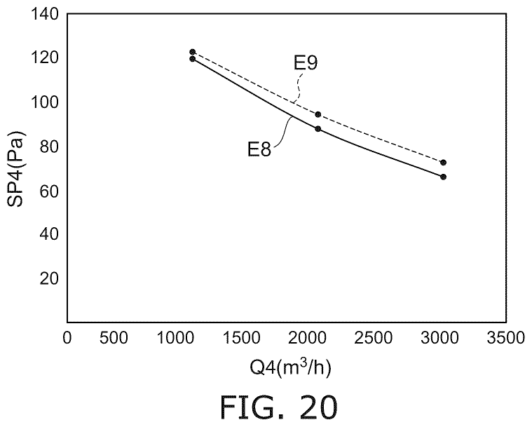

FIG. 20 is a diagram showing characteristics of the blower according to the embodiment. The horizontal axis shown in FIG. 20 represents the air flow rate Q4 (m³/h). The vertical axis represents the static pressure SP4 (Pa). FIG. 20 shows the PQ characteristics. The characteristic E8 shown in the solid line corresponds to a fourth reference example in which the curved surface 12 does not include the plurality of irregularities 50. The characteristic E9 shown in the dashed line corresponds to the embodiment in which the plurality of irregularities 50 are provided on the curved surface 12.

As shown in FIG. 20, the static pressure SP4 of the characteristic E9 is higher than the static pressure SP4 of the characteristic E8. This is because air separation is reduced on the curved surface 12 on the blowoff side SB. As a result, a pressure drop of the air around the plurality of irregularities 50 and the noise of the blower 100 are suppressed. Improved characteristics can be attained.

The bell mouth 10 of the blower 100 according to the embodiment may be used as the wind lens of a wind turbine. Providing the plurality of irregularities 50 in the curved surface portion of the wind lens of a wind turbine can be expected to suppress a pressure drop of the surrounding air and the noise of the wind turbine.

The bell mouth 10 of the blower 100 according to the embodiment may be used as the enclosure of a water turbine or a pump. Providing the plurality of irregularities 50 in the curved surface portion of the enclosure of a water turbine or a pump can be expected to suppress a drop of the pressure of the surrounding water and cavitation caused by the drop of the water pressure.

Hereinabove, embodiments of the invention have been described with reference to specific examples. However, the invention is not limited to these specific examples. For example, one skilled in the art may similarly practice the invention by appropriately selecting specific configurations of components included in the blowers, such as the bell mouth, impeller, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all blowers practicable by an appropriate design modification by one skilled in the art based on the blowers described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A blower comprising:
a bell mouth including an opening portion; and
an impeller provided at the opening portion, including a blade portion including a leading edge portion, and configured to rotate,
the leading edge portion including a plurality of recesses,
the plurality of recesses being arranged in a direction of rotation of the impeller.

2. The blower according to claim 1, wherein
the leading edge portion includes a first portion, and a second portion extending from the first portion in an axial direction, and
the plurality of recesses are provided in the first portion.

3. The blower according to claim 1, wherein
the leading edge portion includes a first portion, and a second portion extending from the first portion in an axial direction, and
the plurality of recesses are provided in the second portion.

4. The blower according to claim 1, wherein the plurality of recesses are riblets.

5. The blower according to claim 4, wherein
a pitch of the riblets is 0.5 mm or more and 4.0 mm or less, and
a depth of the riblets is 0.2 mm or more and 2.0 mm or less.

6. The blower according to claim 1, wherein
the blade portion includes a plurality of blade portions, and
the plurality of blade portions are provided in a circumferential direction.

7. The blower according to claim 1, wherein
the leading edge portion includes a first portion, and a second portion extending from the first portion in an axial direction,
the second portion includes a plurality of steps, and
the plurality of steps are retracted in a direction from an inside to an outside of the impeller along the axial direction.

8. A blower comprising:
a bell mouth including an opening portion; and
an impeller provided at the opening portion, including a blade portion including a leading edge portion, and configured to rotate,
the opening portion including a curved surface,
the curved surface including a plurality of irregularities.

9. The blower according to claim 8, wherein the plurality of irregularities are provided on an air intake side.

10. The blower according to claim 8, wherein the plurality of irregularities are provided on an air blowoff side.

11. The blower according to claim 8, wherein the plurality of irregularities are dimples.

12. The blower according to claim 11, wherein
a pitch of the dimples is 2.0 mm or more and 6.0 mm or less, and
a depth of the dimples is 0.2 mm or more and 0.7 mm or less.
